(19) United States
(12) Patent Application Publication
(10) Pub. No.: US 2007/0279063 A1
(43) Pub. Date: Dec. 6, 2007

(54) Oil-based mud resistivity imaging using resonant circuits

(75) Inventor: David R. Beard, Houston, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: Baker Hughes Incorporated, Houston, TX (US)

(21) Appl. No.: 11/444,640

(22) Filed: Jun. 1, 2006

(51) Int. Cl. G01V 3/00

(52) U.S. Cl. 324/355

(57) ABSTRACT

A resistivity imaging tool determines formation resistivity by evaluating the resonant frequency and the quality factor of a resonant circuit associated with a current electrode. A planar coil electrode may be used to provide the necessary inductance and capacitance for the resonant circuit.

### BACKGROUND OF THE INVENTION

1. Field of the Invention

This invention generally relates to explorations for hydrocarbons involving electrical investigations of a borehole penetrating an earth formation. More specifically, this invention relates to highly localized borehole investigations employing the introduction and measuring of individual survey currents injected into the wall of a borehole by capacitive coupling of electrodes on a tool moved along the borehole with the earth formation.

2. Background of the Art

Electrical earth borehole logging is well known and various devices and various techniques have been described for this purpose. Broadly speaking, there are two categories of devices used in electrical logging devices. In the first category, a measure electrode (current source or sink) are used in conjunction with a diffuse return electrode (such as the tool body). A measure current flows in a circuit that connects a current source to the measure electrode, through the earth formation to the return electrode and back to the current source in the tool. In inductive measuring tools, an antenna within the measuring instrument induces a current flow within the earth formation. The magnitude of the induced current is detected using either the same antenna or a separate receiver antenna. The present invention belongs to the first category.

Examples of galvanic devices are discussed in Birdwell (U.S. Pat. No. 3,365,658), Ajam et al (U.S. Pat. No. 4,122,387), Baker (U.S. Pat. No. 2,930,969), Mann et al. (Canadian Patent 685,727), Gianzero (U.S. Pat. No. 4,468,623), and Dory et al (U.S. Pat. No. 5,502,686).

A drawback with the use of contact devices injecting electrical currents into a wellbore arises when oil-based muds are used in drilling. Oil-based muds must be used when drilling through water soluble formations: an increasing number of present day exploration prospects lie beneath salt layers. Besides reducing the electrical contact between the logging tool and the formation, invasion of porous formations by a resistive, oil-based mud greatly reduces the effectiveness of prior art resistivity imaging devices. This problem is not alleviated by the use of focusing electrodes. U.S. Pat. No. 6,714,014 to Evans et al, having the same assignee as the present invention and the contents of which are fully incorporated herein by reference, discloses an apparatus in which capacitive coupling is used to convey the measure current into the formation through the oil-based mud. The device of Evans uses a very large electrode for the return and assumes that the effect of the gap impedance at the return electrode can be neglected. This assumption may not always be justified.

It would be desirable to have an apparatus and method of determination of formation resistivity that is relatively insensitive to borehole rugosity and can be used with oil-based muds. The present invention satisfies this need.

### SUMMARY OF THE INVENTION

One embodiment of the invention is an apparatus for evaluating an earth formation. The apparatus includes a logging tool conveyed in a borehole in the earth formation. At least one measure electrode conveys a current into the formation. The apparatus includes a resonant circuitry associated with the at least one measure electrode and a processor which measures from the current and a voltage of the resonant circuitry a parameter of interest of the earth formation. The parameter of interest may include a formation resistivity. The at least one electrode may include a plurality of measure electrodes and the parameter of interest may include a resistivity image of the formation. The resonant circuit may include an inductor and/or a capacitor. The measure electrode may be a planar coil electrode which has a capacitance and an inductance. The processor may estimate the parameter of interest based on determination of a resonant frequency of the resonant circuitry and a quality factor of the resonant circuitry. The apparatus may include a wireline or a drilling tubular which conveys the logging tool into the borehole. The apparatus may include a current source which produces current at a plurality of frequencies.

Another embodiment of the present invention is an apparatus for evaluating resonant circuitry. The apparatus includes a current driver which conveys a current to the resonant circuitry, the current having a frequency that is a first function of time. The apparatus further includes a mixer that produces a demodulated signal using a voltage output of the resonance circuitry and a signal representative of the frequency. A processor determines a resonant frequency and a quality factor of the resonant circuit using the demodulated signal and the first function of time.

Another embodiment of the invention is a method of evaluating an earth formation. A current is conveyed into the formation using st least one measure electrode. A voltage of a resonant circuitry associated with the at least one measure electrode is obtained. Using the current and a voltage of the resonant circuitry, a parameter of interest of the earth formation is estimated. The parameter of interest may be a resistivity of the formation. A plurality of measure electrodes may be used and a resistivity image of the formation obtained. The method may include defining the resonant circuitry by using an inductor and/or a capacitor. A planar coil having an inductance and a capacitance may be used. The parameter of interest may be estimated based on determination of a resonant frequency of the resonant circuitry and a quality factor of the resonant circuitry estimated from the voltage and the current. The logging tool may be conveyed into the borehole using a wireline or a drilling tubular. The current may be produced at a plurality of frequencies.

Another embodiment of the invention is a method of evaluating resonant circuitry. A current having a frequency that is a first function of time is conveyed to the resonant circuitry. A voltage output of the resonant circuitry is mixed with a signal representative of the frequency to produce a demodulated signal. A resonant frequency and quality factor of the resonant circuitry are estimated using the demodulated signal and the first function of time.

### BRIEF DESCRIPTION OF THE FIGURES

The present invention is best understood with reference to the accompanying figures in which like numerals refer to like elements and in which:

FIG. 1 shows an imaging tool of this invention suspended in a borehole;

FIG. 2 is a mechanical schematic view of the imaging tool;

FIG. 3 is a schematic circuit diagram of an imaging system used with oil-based mud;

FIG. 4 is a schematic circuit diagram of the prior art device of Evans;

FIG. 5 is a simplified schematic circuit diagram of an imaging device using a button electrode;

FIG. 6 shows the current magnitude and phase for different gaps and formation resistivities for the simplified circuit diagram of FIG. 5 for a 1 MHz current;

FIG. 7a shows the real and imaginary part of the voltage for the circuit of FIG. 5 at a frequency of 40 MHz;

FIG. 7b shows the amplitude and phase of the voltage for the circuit of FIG. 5 at a frequency of 40 MHz;

FIG. 8 illustrates an equivalent circuit in which there is parasitic capacitance at the return electrode;

FIGS. 9a show current and phase without any parasitic capacitance for the circuit of FIG. 8;

FIGS. 9b show current and phase with a parasitic capacitance of 2 pF for the circuit of FIG. 8;

FIG. 10 shows an equivalent circuit of the present invention in which a resonator is provided parallel to the parasitic capacitance;

FIG. 11a, 11b show the response of the circuit of FIG. 10 without (a) and with (b) parasitic capacitance;

FIG. 12 shows an equivalent circuit of another embodiment of the present invention in which the inductance is less than in FIG. 10;

FIG. 13 is a block diagram of circuitry used to implement a logging tool including a resonator; and

FIG. 14 is an illustration of a planar coil electrode which includes an internal inductance.

### DETAILED DESCRIPTION OF THE INVENTION

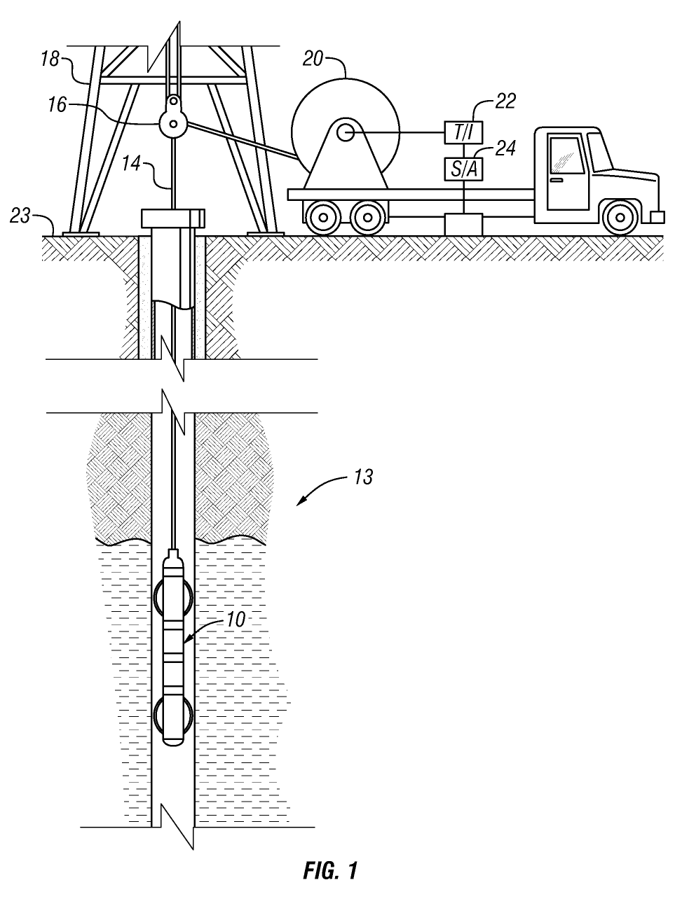

FIG. 1 shows an imaging tool 10 suspended in a borehole 12, that penetrates earth formations such as 13, from a suitable cable 14 that passes over a sheave 16 mounted on drilling rig 18. By industry standard, the cable 14 includes a stress member and seven conductors for transmitting commands to the tool and for receiving data back from the tool as well as power for the tool. The tool 10 is raised and lowered by draw works 20. Electronic module 22, on the surface 23, transmits the required operating commands downhole and in return, receives data back which may be recorded on an archival storage medium of any desired type for concurrent or later processing. The data may be transmitted in analog or digital form. Data processors such as a suitable computer 24, may be provided for performing data analysis in the field in real time or the recorded data may be sent to a processing center or both for post processing of the data.

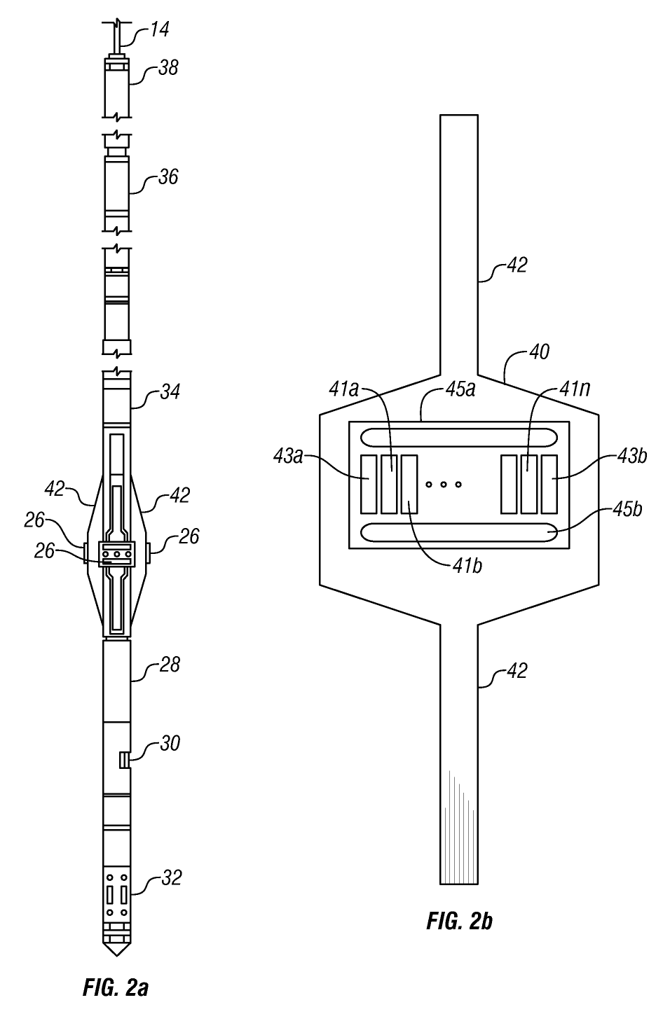

FIG. 2 is a schematic external view of a borehole sidewall imager system. The tool 10 comprising the imager system includes resistivity arrays 26 and, optionally, a mud cell 30 and a circumferential acoustic televiewer 32. Electronics modules 28 and 38 may be located at suitable locations in the system and not necessarily in the locations indicated. The components may be mounted on a mandrel 34 in a conventional well-known manner. The outer diameter of the assembly is about 5 inches and about fifteen feet long. An orientation module 36 including a magnetometer and an accelerometer or inertial guidance system may be mounted above the imaging assemblies 26 and 32. The upper portion 38 of the tool 10 contains a telemetry module for sampling, digitizing and transmission of the data samples from the various components uphole to surface electronics 22 in a conventional manner. If acoustic data are acquired, they are preferably digitized, although in an alternate arrangement, the data may be retained in analog form for transmission to the surface where it is later digitized by surface electronics 22.

Also shown in FIG. 2 are three resistivity arrays 26 (a fourth array is hidden in this view). Referring to FIGS. 2 and 2A, each array includes measure electrodes 41a, 41b . . . 41n for injecting electrical currents into the formation, focusing electrodes 43a, 43b for horizontal focusing of the electrical currents from the measure electrodes and focusing electrodes 45a, 45b for vertical focusing of the electrical currents from the measure electrodes. By convention, “vertical” refers to the direction along the axis of the borehole and “horizontal” refers to a plane perpendicular to the vertical.

Other embodiments of the invention may be used in measurement-while-drilling (MWD), logging-while-drilling (LWD) or logging-while-tripping (LWT) operations. The sensor assembly may be used on a substantially non-rotating pad as taught in U.S. Pat. No. 6,173,793 having the same assignee as the present application and the contents of which are fully incorporated herein by reference. The sensor assembly may also be used on a non-rotating sleeve such as that disclosed in U.S. Pat. No. 6,247,542 to Kruspe et al., having the same assignee as the present invention and the contents of which are fully incorporated here by reference.

For a 5″ (12.7 cm) diameter assembly, each pad can be no more than about 4.0 inches (10.2 cm) wide. The pads are secured to extendable arms such as 42. Hydraulic or spring-loaded caliper-arm actuators (not shown) of any well-known type extend the pads and their electrodes against the borehole sidewall for resistivity measurements. In addition, the extendable caliper arms 42 provide the actual measurement of the borehole diameter as is well known in the art. Using time-division multiplexing, the voltage drop and current flow is measured between a common electrode on the tool and the respective electrodes on each array to furnish a measure of the resistivity of the sidewall (or its inverse, conductivity) as a function of azimuth.

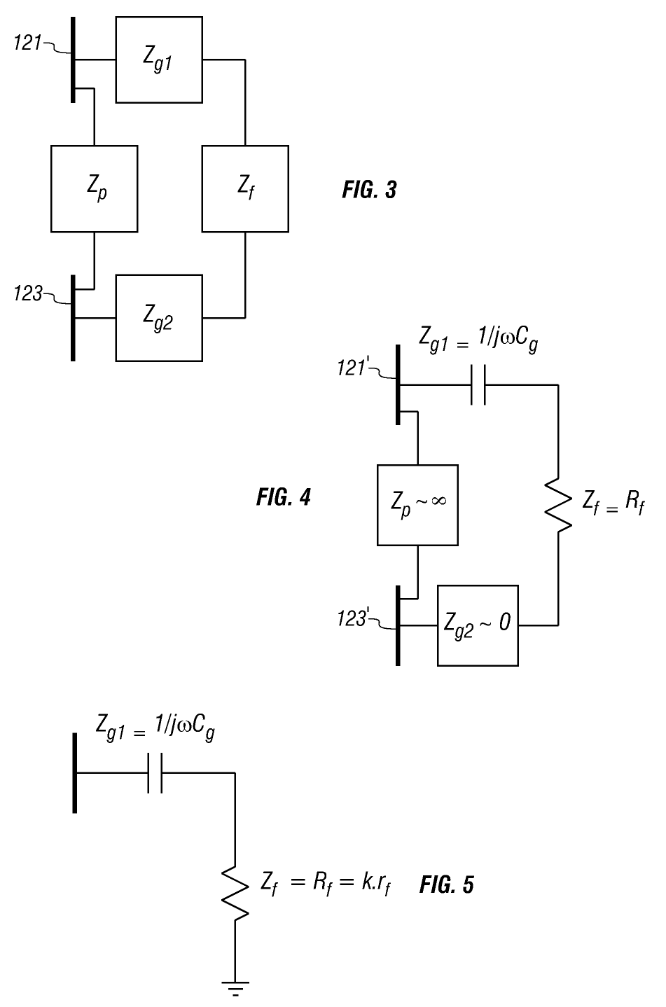

FIG. 3 shows an equivalent circuit of an imaging system used with oil-based mud. The current electrode is depicted by 121 and the return electrode is depicted by 123. The gap (standoff) between the current electrode and the formation has an impedance denoted by Z_{g1} while the gap between the return electrode and the formation has an impedance denoted by Z_{g2}. The formation has an impedance Z_{f} The objective of the system is to determine the formation impedance Z_{f} from current and voltage measurements at the electrodes 121/123.

FIG. 4 shows the equivalent circuit of an imaging system assumed in the Evans device. The current electrode is depicted by 121′ and the return electrode is depicted by 123′. The impedance of the current electrode gap is assumed to be purely capacitive and given by

$${Z}_{g} = \frac{1}{jω {C}_{g}}$$

where ω is the angular frequency and C_{g} is the capacitance of the gap. The impedance of gap between the return electrode and the formation Z_{g2} is ignored as being zero and the parasitic impedance Zₚ is assumed to be infinite.

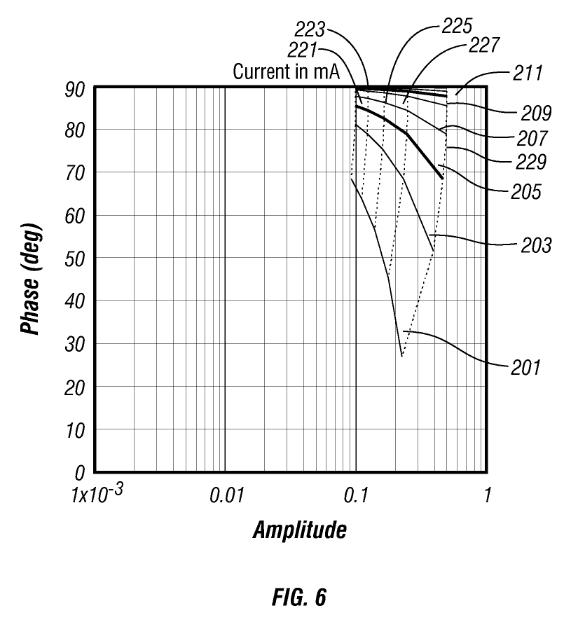

The analysis of the imaging system using a button electrode starts with the simplified circuit of FIG. 5. The current amplitude and phase for the model are shown in FIG. 6. The abscissa is the current amplitude and the ordinate is the phase. The applied voltage is 10V at 1 MHz. The curves 201, 203, 205, 207, 209 and 211 show currents corresponding to formation resistivities of 500 ω-m, 200 Ω-m, 100 Ω-m, 50 Ω-m, 20 Ω-m and 10 Ω-m respectively. The curves 221, 223,225, 227 and 229 shows the phase shift between the applied voltage and the current corresponding to gaps of 0.25 in., 0.2 in, 0.15 in, 0.1 in and 0.05 in. respectively. It can be seen that for formation resistivity r_{f}>20 Ω-m, the current measurements are sensitive to the formation resistivity. Phase measurements would improve the results for r_{f}>10 Ω-m.

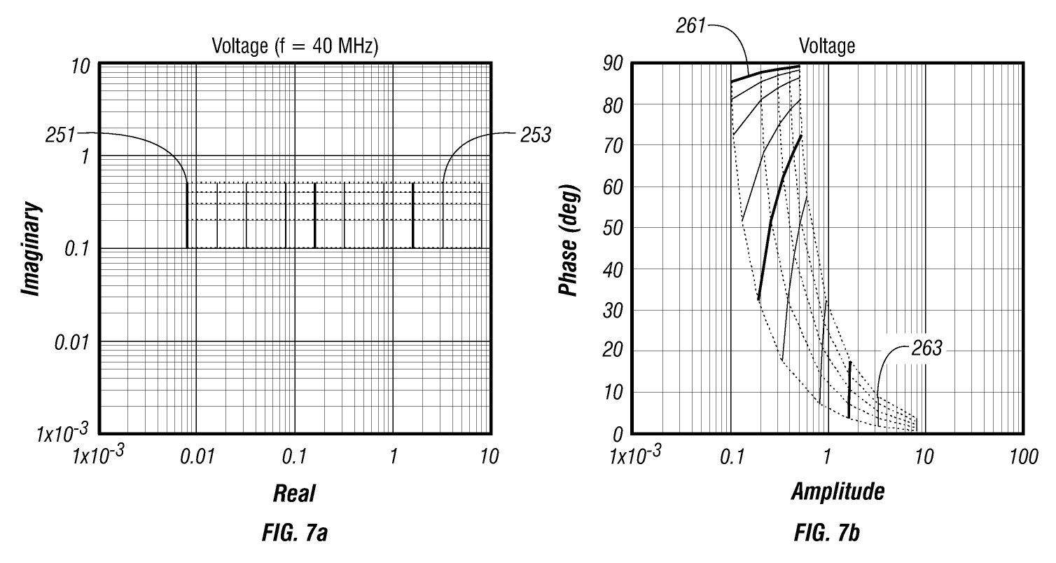

Turning now to FIG. 7a, a plot of the real (abscissa) and the imaginary (ordinate) voltage for a current of 0.2 mA at 40 MFz is shown. The curve 251 is for r_{f}=0.5 Ω-m while the curve 253 is for r_{f}=200 Ω-m. The curves corresponding to intermediate values of r_{f} are plotted but not identified by reference numerals to simplify the illustration. Corresponding curves in FIG. 7_{b} are 261 and 263 where the abscissa is the amplitude and the ordinate is the phase. FIGS. 7a and 7b suggest that it should be relatively easy to estimate the formation resistivity. This optimistic picture changes when parasitic capacitance is considered.

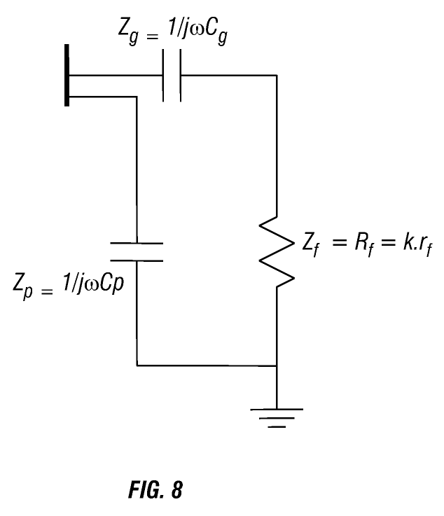

FIG. 8 illustrates the equivalent circuit in the presence of parasitic capacitance denoted by

$${Z}_{p} = \frac{1}{jω {C}_{p}} .$$

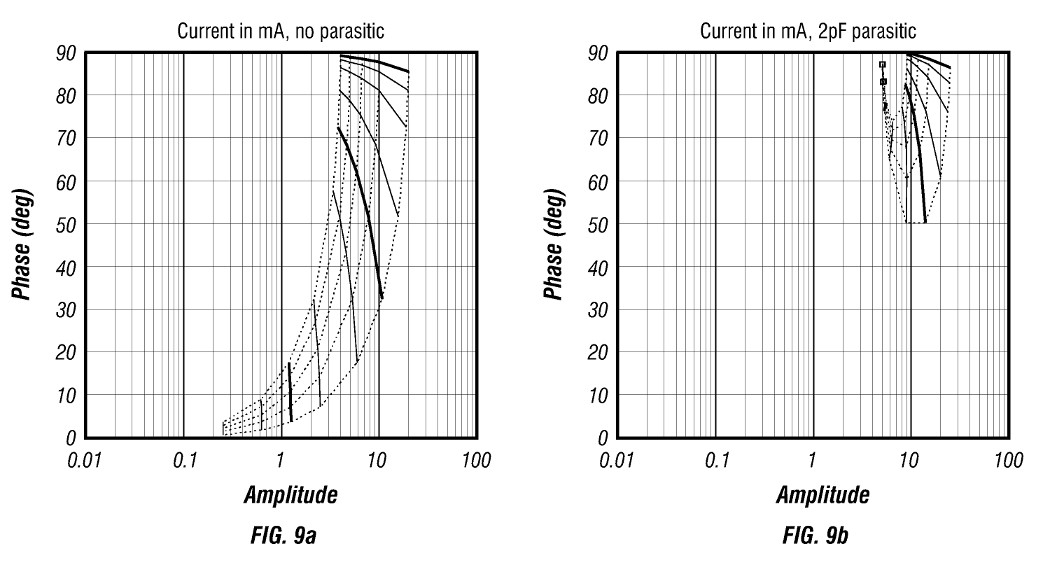

Note that in FIG. 8, the formation is depicted as being purely resistive with a resistance of R_{f} that is the product of the formation resistivity r_{f} and a tool factor k. FIG. 9a shows exemplary response curves at 40 MHz (solid lines correspond to different formation resistivity values and dashed lines correspond to different gaps) when the parasitic capacitance is zero, i.e., the impedance is infinite. The range of values of formation resistivity r_{f} and gap is the same as in FIG. 6, but the individual curves are not numbered to simplify the illustration. The important point to not is that he curves show sensitivity to the formation resistivity. FIG. 9b shows the same curves when there is a parasitic capacitance of 2 pF present. The difference from FIG. 9a is quite dramatic—there is hardly any sensitivity to formation resistivity and gap, and suggests that at 40 MHz, it would be difficult to use amplitude and phase measurements to determine formation resistivity. Increased separation is observed (not shown) at 10 MHz, but determination of formation resistivity is still problematic.

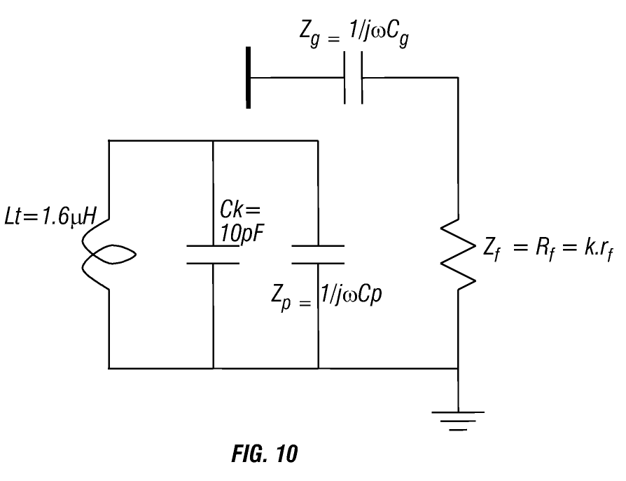

FIG. 10 is a circuit diagram illustrating an embodiment of the present invention that addresses the problem of parasitic capacitance. A resonant circuit denoted by the inductor Lₜ and capacitor Cₖ is introduced in parallel with the (unknown) parasitic capacitance Zₚ. In theory, at resonance, effect of all parallel caps is removed. The invention measures the resonant frequency and Q of the circuit. These can both be determined without any phase detection and without knowing the gain of the receiver circuitry. The inductor should be of high quality (Q˜100) and capable of operating at the chosen frequency. In the example shown, the inductance is shown as 1.6 μH and the additional capacitance is shown as 10 pF. These values are not to be construed as limitations to the invention.

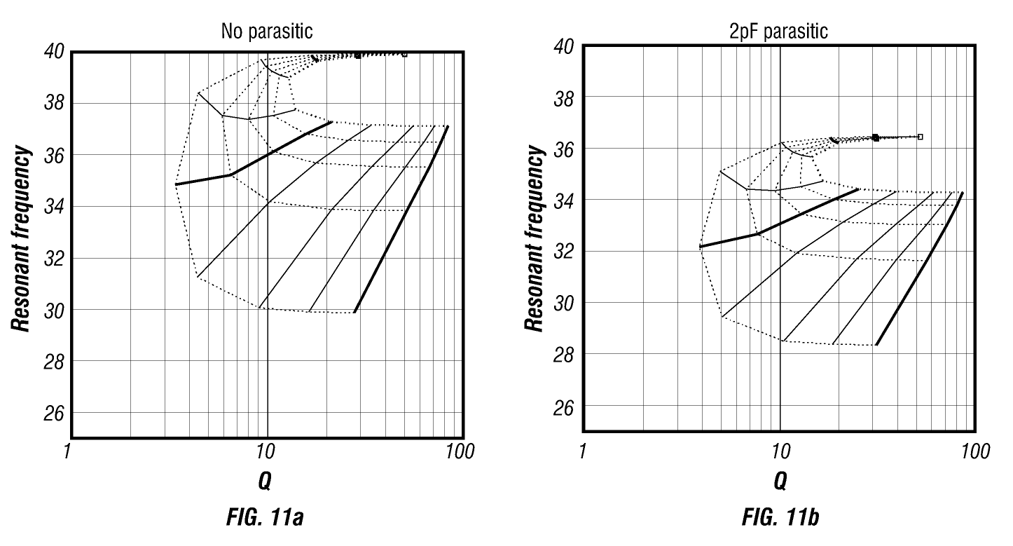

FIGS. 11a and 11b show the response curves for the circuit of FIG. 10 to a range of formation resistivities and tool standoff. FIG. 11a is for zero parasitic capacitance while FIG. 11b is for a parasitic capacitance of 2 pF. The individual curves are not labeled to simplify the illustration. Both figures show that the resonant circuit of FIG. 10 has a good sensitivity to the formation resistivity.

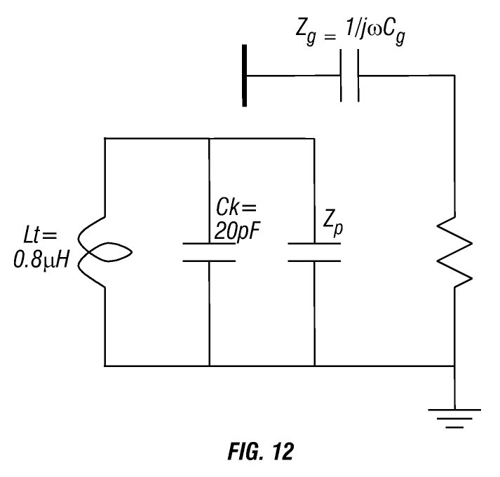

FIG. 12 shows an equivalent circuit of an alternate embodiment of the invention in which the inductance is reduced from 1.6 μH to 0.8 μH and the capacitance is increased from 20 pF to 40 pF. This resonator has substantially the same resonant frequency as that of FIG. 10, but may be easier to implement. The response curves for the circuit of FIG. 12 are not shown, but do demonstrate sensitivity to the formation resistivity.

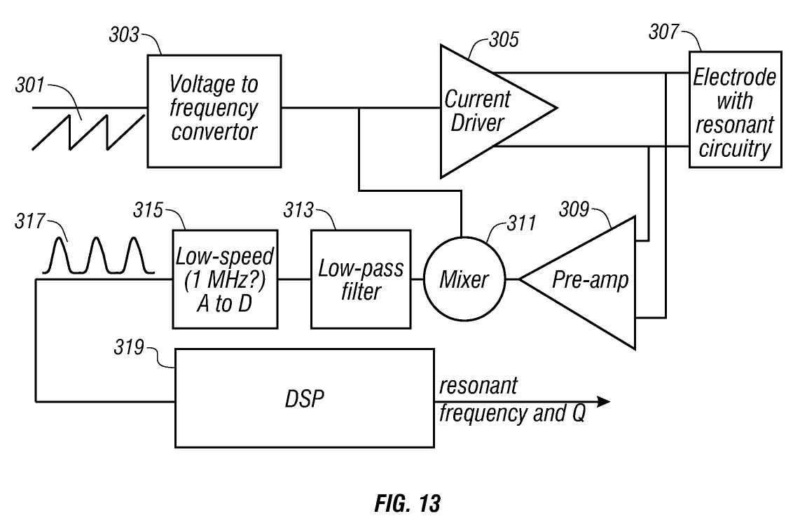

Turning to FIG. 13, a block diagram of circuitry that implements a logging tool including resonant circuitry is shown. The electrode and the resonant circuitry are generally denoted by 307. A current driver 305 provides a time-varying current having a variable frequency to the electrode based on the output of a frequency converter 303. In the example shown, the input to the frequency converter may be a sawtooth function such as that depicted by 301. The sawtooth function may be a low frequency control signal at a frequency of, for example, 10 kHz. The frequency converter 303 may produce an output with a frequency range of, for example, 35 MHZ to 45 MHz.

Still referring to FIG. 13, the voltage output of the electrode/resonant circuitry combination 307 is passed through a preamplifier 309 and is the first input to a mixer 311. The first input to the mixer is a signal that has (i) a variable frequency determined by the frequency of the driving current, and (ii) is modulated by the voltage output of the resonant circuitry. The second input to the mixer 311 is the signal to the current driver 305. The output of the mixer will comprise the sum and difference frequencies of the two inputs to the mixer. The difference frequency is the voltage that is low-pass filtered 313, converted to a digital signal by the A/D converter 315. The output 317 of the A/D converter 315 will track the “sawtooth” signal and will have a maximum at the resonant frequency of the circuit 307. The 3 dB points of these maxima define the Q of the resonant circuit. A suitable DSP 319 may be used to analyze the signal 317 to give the Q and resonant frequency of the circuit. A look-up table may then be used to determine the formation resistivity from the resonant frequency and the Q. Simply stated, the Q of a circuit is the ratio of its reactance to its resistance. High Q circuits have very high and narrow resonant peaks in the frequency response function. Table lookups for Q and resonant frequencies can be done in much the same way as table lookups are done for amplitude and phase, or for real and imaginary parts of the signal in prior art methods.

Those versed in the art and having the benefit of the present disclosure would recognize from FIGS. 11a and 11b that the table lookup procedure could be improved if the gap is known. Accordingly, in one embodiment of the invention, a caliper is used to measure the standoff. The caliper may be an acoustic caliper or a mechanical caliper.

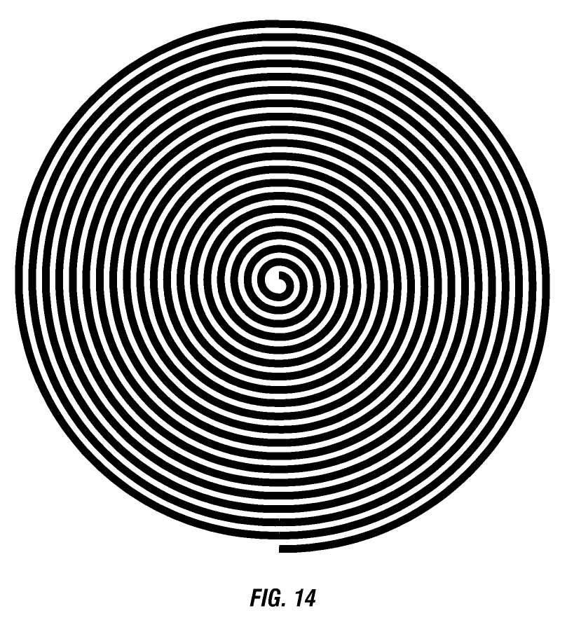

In one embodiment of the invention, instead of a conventional button electrode, a planar coil electrode schematically illustrated in FIG. 14 may be used. Current injected from the inner turns will return on the outer turns, so the resolution of the coil would be about 0.5 in. for a coil diameter of 1 in. A coil electrode such as that shown in FIG. 14, has both an internal inductance and a capacitance. Hence when such an electrode is used in the present invention, it may not be necessary to provide the additional capacitance Cₖ of FIGS. 10 and 12.

For the purposes of the present invention, we refer to circuitry associated with the measure electrode (such as the circuitry denoted by 307) having an inductance and a capacitance as a resonant circuit. The capacitance includes the parasitic capacitance Cₚ, the gap capacitance C_{g} and the capacitance Cₖ (see FIGS. 10 and 12). All or part of the capacitance Cₖ may be provided by using a coil electrode as shown in FIG. 14. The circuitry associated with the measure electrode also includes an inductance Lₜ. At least a part of this inductance may be provided by using a coil electrode. Together with the impedance of the formation Z_{f}, the circuitry has an associated resonance frequency and quality factor Q. If a planar coil is used as the electrode, the resonant frequency of the circuit will be somewhat lower than the resonant frequency of the coil due to the presence of the parasitic capacitance Cₚ.

The apparatus discussed above when implemented with a single electrode may be used to determine a parameter of interest of the earth formation such as formation resistivity. When implemented with a plurality of electrodes on one or more pads extended away from a body of a logging tool, the apparatus may be used to obtain a resistivity image of a wall of the borehole.

The invention has further been described by reference to logging tools that are intended to be conveyed on a wireline. However, the method of the present invention may also be used with measurement-while-drilling (MWD) tools, or logging while drilling (LWD) tools, either of which may be conveyed on a drillstring or on coiled tubing.

While the foregoing disclosure is directed to the preferred embodiments of the invention, various modifications will be apparent to those skilled in the art. It is intended that all variations within the scope and spirit of the appended claims be embraced by the foregoing disclosure.

1. An apparatus for evaluating an earth formation, the apparatus comprising:
(a) a logging tool configured to be conveyed in a borehole in the formation;
(b) at least one measure electrode which is configured to convey a current into the formation;
(c) a resonant circuitry associated with the at least one measure electrode;
(d) a processor which is configured to estimate from the current and a voltage of the resonant circuitry a value of a parameter of interest of the earth formation and to record the estimated value ona tangible medium.

2. The apparatus of claim 1 wherein the parameter of interest comprises a resistivity of the earth formation.

3. The apparatus of claim 1 wherein the at least one measure electrode further comprises a plurality of electrodes configured to be disposed on a pad and wherein the parameter of interest further comprises a resistivity image of the formation.

4. The apparatus of claim 1 wherein the resonant circuitry further comprises at least one of (i) an inductor, and (ii) a capacitor.

5. The apparatus of claim 1 wherein the at least one measure electrode further comprises a planar coil electrode having a capacitance and an inductance.

6. The apparatus of claim 1 wherein the processor is configured to estimate the value of the parameter of interest based on a determination of a resonant frequency of the resonant circuitry and a quality factor of the resonant circuitry estimated from the voltage and the current.

7. The apparatus of claim 1 further comprising a conveyance device which is configured to convey the logging tool into the borehole, the conveyance device selected from (i) a wireline, and (ii) a drilling tubular.

8. The apparatus of claim 1 further comprising a current source coupled to the resonant circuitry, the current source configured to produce current at a plurality of frequencies.

9. An apparatus for evaluating a resonant circuitry, the apparatus comprising:
(a) a current driver which conveys a current to the resonant circuitry, the current having a frequency that is a first function of time,
(b) a mixer that produces a demodulated signal using a voltage output of the resonant circuitry and a signal representative of said frequency; and
(c) a processor which determines a resonant frequency and a quality factor of the resonant circuit using the demodulated signal and the first function of time.

10. A method of evaluating an earth formation, the method comprising:
(a) using at least one measure electrode to convey a current into the formation;
(b) obtaining a voltage of a resonant circuitry associated with the at least one measure electrode;
(c) estimating from the current and a voltage of the resonant circuitry a value of a parameter of interest of the earth formation; and
(d) recording the estimated value on a tangible medium.

11. The method of claim 10 wherein the parameter of interest comprises a resistivity of the earth formation.

12. The method of claim 10 further comprising using, as the at least one measure electrode, a plurality of electrodes disposed on a pad, and wherein the parameter of interest further comprises a resistivity image of the formation.

13. The method of claim 10 further defining a resonant frequency of the resonant circuitry using at least one of (i) an inductor, and (ii) a capacitor.

14. The method of claim 10 further comprising using, as the at least one measure electrode, a planar coil electrode having a capacitance and an inductance.

15. The method of claim 10 further comprising estimating the value of the parameter of interest based on a determination of a resonant frequency of the resonant circuitry and a quality factor of the resonant circuitry estimated from the voltage and the current.

16. The method of claim 10 further comprising disposing the at least one electrode on a logging tool and conveying the logging tool into the borehole, using one of (i) a wireline, and (ii) a drilling tubular.

17. The method of claim 10 further comprising producing the current at a plurality of frequencies.

18. A method of evaluating a resonant circuitry, the apparatus comprising:
(a) conveying a current to the resonant circuitry, the current having a frequency that is a first function of time,
(b) mixing a voltage output of the resonant circuitry with a signal representative of the frequency to produce a demodulated signal; and
(c) estimating a resonant frequency and a quality factor of the resonant circuit using the demodulated signal and the first function of time.
